(19) United States
(12) Patent Application Publication
(10) Pub. No.: US 2014/0308086 A1
(43) Pub. Date: Oct. 16, 2014

(54) DRILL HEAD

(71) Applicant: KENNAMETAL, INC., Latrobe, PA (US)

(72) Inventors: HERBERT RUDOLF KAUPER, Erlangen (DE); JUERGEN SCHWAEGERL, Vohenstrauss (DE)

(73) Assignee: KENNAMETAL, INC., Latrobe, PA (US)

(21) Appl. No.: 14/250,943

(22) Filed: Apr. 11, 2014

(30) Foreign Application Priority Data
Apr. 12, 2013 (DE) 102013206549.3

(51) Int. Cl. B23B 51/02

(52) U.S. Cl. CPC B23B 51/02; B23B 2251/18
USPC 408/227

(57) ABSTRACT

A tool head includes a main body having a nominal diameter, a face end center formed on the main body, and at least two major cutting edges which each run radially outward from and adjoin the face end center. The face end center is formed by a cone of circular cross-sectional area, which cone extends from a cone apex through to a cone base.

### BACKGROUND

1. Field of the Invention

Embodiments of the present invention relate to a tool head, in particular a drill head, having a face end center and having at least two major cutting edges, which, running respectively radially outward, adjoin the face end center and define a nominal diameter.

2. Background Information

In high-precision workpiece machining, in particular in high-precision drilling operations, good guidance of the drilling tool is critically important at the start of the drilling process. Drilling tools for precision bores in metal working usually have precisely ground drill heads. These typically have at least two major cutting edges, which are connected to each other in the region of the face end center via a chisel edge. Since, in the region of the chisel edge, due to its position symmetrical to a central longitudinal axis of the drilling tool, the cutting speed in the drilling process is very low or amounts to zero, no cutting, but merely a pressing, takes place in this region. This leads to a situation in which, particularly at the commencement of the drilling process, a certain deflection takes place, which can lead to wobbling of the tool.

In order to lessen this effect, in the region of the chisel edge a so-called pointing is usually provided in order to keep the diameter of the face end center, which is bridged by the chisel edge, as low as possible.

In some cases it is also known, in order to improve the self-centering of the drill in the face end center, to provide a distinctive drill bit, as can be derived, for instance, from U.S. Pat. No. 2,903,922, U.S. Pat. No. 5,288,183 or U.S. Pat. No. 8,061,938 B2.

Finally, for rock drills, an embodiment comprising a total of four major cutting edges, which in the face end center at the edges of a pyramidal frustum, are continued onward to the tip of a pyramid, can be derived from U.S. Pat. No. 6,910,838 B2.

### SUMMARY OF THE INVENTION

Starting therefrom, a basis for the present invention is to define a tool head, in particular a drill head, which, particularly for high-precision machining of metallic materials, ensures improved centering and guidance of the drill at the commencement of the drilling process.

Such goal is achieved according to the invention by a tool head, in particular a drill head. According to this, the drill head has a face end center adjoined by at least two major cutting edges, which respectively run radially outward. The drill head here has a nominal diameter which is defined by the radially outermost point of the end major cutting edge. The major cutting edges can here extend continuously and without interruption from the face end center to the nominal radius, or else—as in a stepped drill, for instance—can be interrupted, so that two major cutting edge portions, which are arranged mutually offset in the axial direction, are formed.

It is now of particular importance that the face end center is formed by a cone of circular cross-sectional area. The cone here extends from a front cone apex to a rear cone base.

As a result of this measure, a highly symmetrical centering point, having a sharp, pointed cone apex, is formed, so that in the drilling process a defined point contact is realized and thus there is no danger of deflection. Furthermore, it is of particular importance that the cone has a circular base area, so that the conical surface likewise has no kind of preferred direction etc. This ensures that, when the cone shell engages in the workpiece, no deflection forces or asymmetrical forces, which could in turn lead to unwanted deflection of the drilling tool, are generated. The cone shell is therefore preferably completely smooth and edgeless. A highly symmetrical cone of this type can preferably be produced in a simple manner by means of a grinding process, by high-precision circular grinding.

Expediently, the cone base, adjoined by the major cutting edges, has a diameter within the range of between 1% and 5%, preferably between 2% and 3%, of the nominal diameter. In total, the cone base, and thus the face end center, therefore has a smallest possible diameter. The center region, which is free of cutting edges, is thereby kept as small as possible, since in the region of the cone only a deflection, and no cutting, takes place.

In an expedient refinement, the cone has a height within the range of likewise between 1% and 5%, and in particular between 2% and 3%, of the nominal diameter. In total, therefore, a comparatively small cone, which merely forms a sharp-pointed, yet highly symmetrical centering point, is thereby formed.

The transition from the cone into the major cutting edges is preferably rounded. Between the cone base and the major cutting edges, as well as correspondingly also between the cone base and a flank adjoining the respective major cutting edges, no sharp edge is therefore formed. As a result, notch stresses are kept low.

In order to achieve the desired small diameter of the face end center, in a preferred embodiment a pointing is performed in the region of the face end center. Each of the major cutting edges is usually assigned to a chip groove. The pointing is usually performed by a separate grinding step in the chip groove in the region of the face end center. In the front tip region, a tapering of the drill core is therefore realized, as is known in traditional drills having chisel edges. The combination of the cone as together with the pointing centering points therefore reinforces the desired effect of high-precision centering, since the diameter of the non-cutting cone is hereby limited to a smallest possible diameter.

The cone base preferably adjoins the pointing. In particular, the pointing ends before, in particular directly before the cone base. The high rotational symmetry of the circular cone through to the cone base is thereby ensured.

In an alternative embodiment, the pointing extends into the cone over a small segment, for instance maximally 10% or maximally 20% of the height of the cone. An increased tolerance is therefore permitted in respect of the grinding. In principle, the circular cross-sectional area is desired.

The cone is generally of very pointed configuration and has a cone angle which lies within the range from 30° to 50°, and in an example embodiment in the region of 40°.

At the same time, the major cutting edges are arranged at a customary point angle, which lies within the range from 130° to 135° and, in particular, typically around 135°. All in all, the conical centering point is also hereby kept as small as possible in order to overall maintain the characteristics of a customary standard drill head provided, for instance, with a traditional end face drill point, for example a conical drill point, a tetrahedral drill point, etc.

The cone is expediently divided into a front cone portion, which extends through to the cone apex, and a rear cone portion, which extends through to the cone base. The two cone portions here have different cone angles. As a result of this measure, on the one hand the cone apex, and on the other hand the cone base and the transition to the major cutting edges, can be configured in the desired manner. Both cone portions here respectively have the circular cross-sectional area.

Furthermore, the drill head is expediently configured in total as a reversibly exchangeable drill head and is, to this end, in particular a monolithic insert, consisting, for instance, of hard metal, or is a metallic or ceramic sintered body. For the reversibly exchangeable fastening, the drill head 2 usually has a coupling pin, with which it can be inserted into a corresponding coupling receptacle of a carrier. In total, the drill head is therefore configured for a modular carrier tool. In the event of a worn drill head, this merely needs to be exchanged. Expediently, the coupling is here configured as a toolless, in particular clamping coupling. In monolithic parts of this type, the drill head itself has a main body, in which the chip grooves are provided. The cutting edges are usually formed by grinding, as is the cone described here.

### BRIEF DESCRIPTION OF THE ACCOMPANYING FIGURES

Novel features and characteristics of the disclosure are set forth in the appended claims. The disclosure itself, however, as well as a preferred mode of use, further objectives and advantages thereof, will best be understood by reference to the following description of an illustrative embodiment when read in conjunction with the accompanying figures. One or more embodiments are now described, by way of example only, with reference to the accompanying figures, in which, partially in simplified representations:

FIG. 1 shows a slightly perspective, partial representation of a drill head,

FIG. 2 shows a side view of the partial representation according to FIG. 1,

FIG. 3 shows a front view of the drill head according to FIG. 1,

FIG. 4 shows a partial enlarged representation of the front view according to FIG. 3,

FIG. 5 shows a partial top view of a horizontal sectional plane through the drill head, wherein the sectional plane runs through the tip-side cone roughly at mid-height of the cone,

FIG. 6 shows a partial top view of a horizontal sectional plane through the drill head, wherein the sectional plane lies somewhat below the cone in the transitional region to the major cutting edges,

FIG. 7 shows a longitudinal section through the drill head, and

FIG. 8 shows an enlarged representation of the sectional view according to FIG. 7 in the region of the cone.

### DETAILED DESCRIPTION

The foregoing has broadly outlined features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiments disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the disclosure.

The drill head 2 represented in the figures is configured as a reversibly exchangeable drill head 2 for a modular carrier tool and has a coupling (not represented in detail here). The drill head 2 extends along a center or rotational axis 3 in the axial direction. It consists of a monolithic main body 4 having two major cutting edges 6, wherein a helical chip groove 8 is assigned to each major cutting edge 6. The chip grooves are provided in the main body 4. The major cutting edges 6 are ground by a grinding process. The major cutting edges 6 extend generally in a roughly radial direction through to an outer cutting corner 10, by which a nominal diameter D (FIG. 3) is defined. Starting from the cutting corner 10, a minor cutting edge 12, which is adjoined in the peripheral direction by a bevel, runs in the axial direction along the chip groove 8. That wall of the respective chip groove 8 which runs ahead of the cutting corner 10 has a step having a stop face 13, which is gripped by a web of a carrier in order to transmit a torque from the carrier to the drill head 2 during operation.

The major cutting edges 6 are respectively adjoined in the peripheral direction, on the end face, by flanks 14, which respectively extend through to the following chip groove 8. The end face of the drill head 2—apart from a face end center—is provided with a traditional end face ground surface, in the illustrative embodiment a conical ground surface.

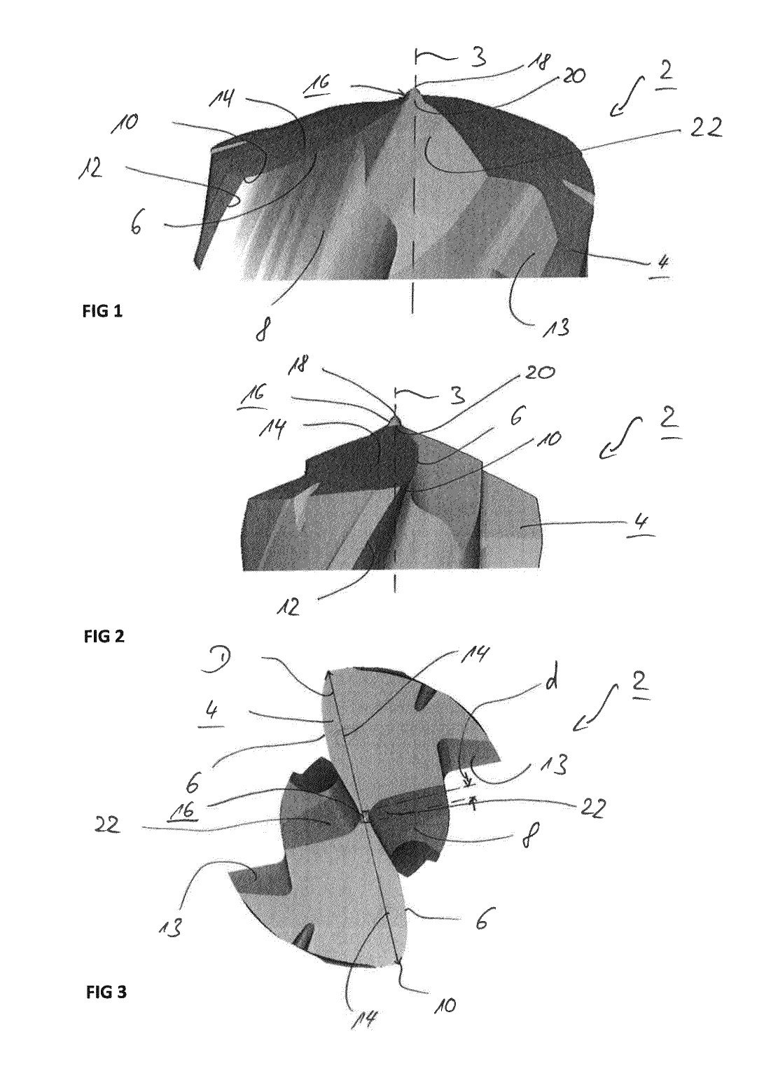

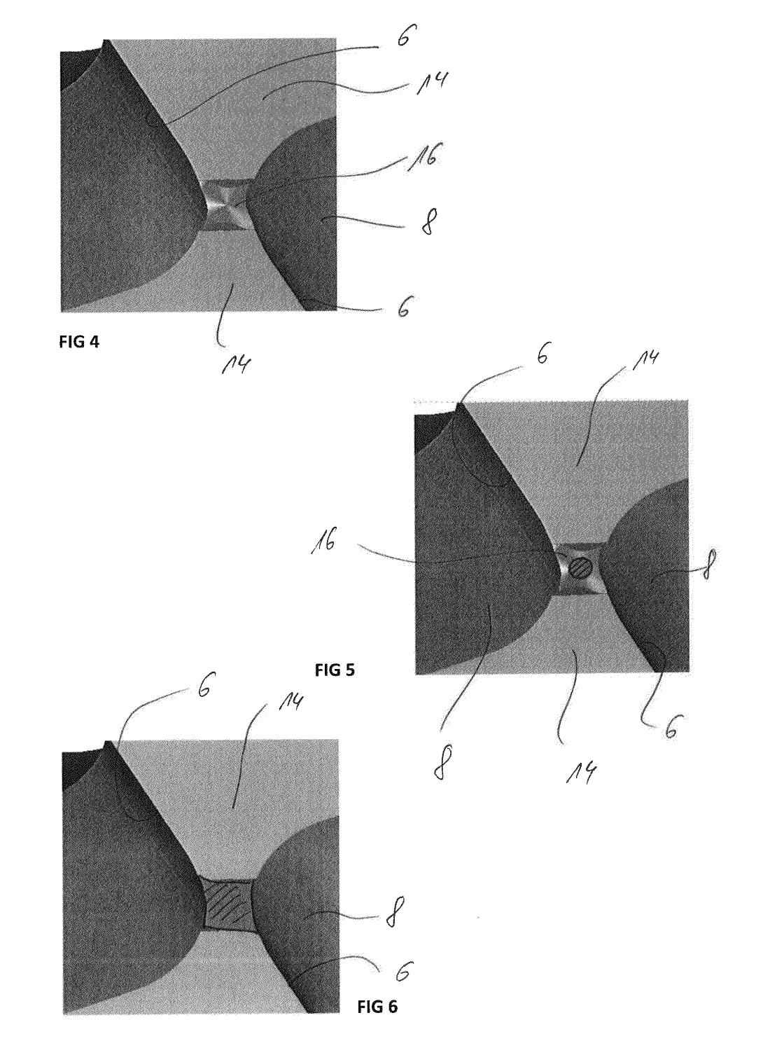

The major cutting edges 6 extend in the direction of the drill middle through to a cone 16, which defines the face end center. The cone 16 here extends from a cone apex 18 through to a cone base 20. The cone 16 has in total a diameter d and a height h (FIG. 8). In order to keep the diameter d as small as possible, a pointing 22 (FIGS. 1, 3) is ground in the respective chip grooves 8 by a grinding process. As can be seen in particular from FIGS. 1 and 2, in the illustrative embodiment, the end face of the drill head 2 is configured in total in the style of a conical surface, from which, in the center, the cone 16 protrudes. The cone apex 18 here lies exactly on the center and rotational axis 3 of the drill head 2.

The cone 16 has in total a circular cross-sectional area, as emerges, in particular, from the cross-sectional view according to FIG. 5. In the region of its cone base 20, the cone 16 then merges, on the one hand, into the major cutting edges 6 and, on the other hand, into the flanks 14. In this transitional region, the cross-sectional geometry of the circular cross-sectional area therefore changes from the circular cross-sectional area to a roughly trapezoidal cross-sectional area, as can be seen from FIG. 6. The flanks 14 adjoining the major cutting edges 6 fall somewhat behind the major cutting edges 6 due to the formation of a clearance angle, whereby the cross-sectional area represented in FIG. 6 is obtained.

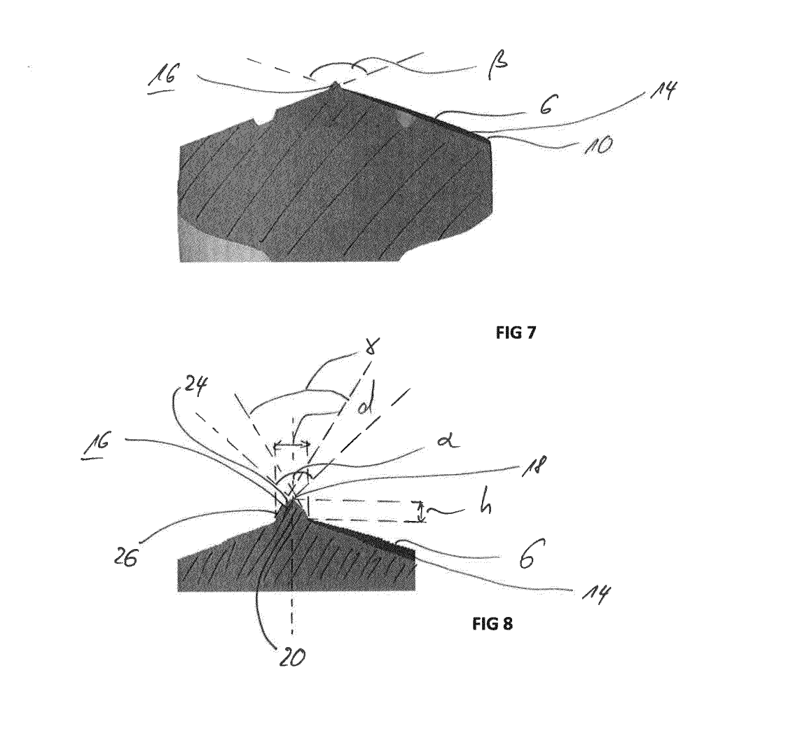

With reference to the longitudinal sectional representations of FIG. 7 and FIG. 8, which show a sectional plane in the axial direction along the rotational axis 3, the shape of the cone 16 can once again be seen.

In these FIGS. 7 and 8 is represented a construction variant in which the cone 16 has two portions, namely a front cone portion 24, which comprises the cone apex 18, and a rear cone portion 26, which is delimited at the end by the cone base 20. The two cone portions 24, 26 have different cone angles. The cone apex 18 generally has a cone angle a which is preferably around 40°. In the variant represented in FIG. 8, having the plurality of cone portions 24, 26, the rear cone portion 26 has a cone angle γ which, in the illustrative embodiment, is less than the cone angle α. At the same time, the major cutting edges 6 are oriented at a point angle β to each other in the region of typically around 135°.

The here described drill head is used, in particular, for drilling metallic materials, as well as cast metal materials. In the case of the metallic materials, soft materials, such as, for instance, aluminum or comparable metals, are preferably machined with a drill head 2 of this type. Such a drill head 2 exhibits particular advantages in the machining of cast metal materials, since these have a comparatively inhomogeneous material structure with hard-soft differences, which, in traditional drill heads, often leads to undesirable displacement. By virtue of the here described cone 16 having the sharp cone apex 18, the drill head 2 is held, by contrast, exactly at the desired position on the rotational axis at the start of the drilling process and a deflection is at least largely avoided. Wobbling of the drilling tool in the further drilling process is thereby avoided or at least reduced, so that the drill hole quality, in particular roundness and tolerance accuracy, is improved overall.

1. A tool head comprising:
a main body having a nominal diameter;
a face end center formed on the main body; and
at least two major cutting edges which each run radially outward from and adjoin the face end center,
wherein the face end center is formed by a cone of circular cross-sectional area, which cone extends from a cone apex through to a cone base.

2. The tool head as recited in claim 1, wherein the cone base has a diameter within the range of between 1% and 5% of the nominal diameter.

3. The tool head as recited in claim 1, wherein the cone base has a diameter within the range of between 2% and 3% of the nominal diameter.

4. The tool head as recited in claim 1, wherein the cone has a height within the range of between 1% and 5% of the nominal diameter.

5. The tool head as recited in claim 1, wherein the cone has a height within the range of between 2% and 3% of the nominal diameter.

6. The tool head as recited in claim 1 further comprising a rounded transition from the cone base to the respective major cutting edge.

7. The tool head as recited in claim 1, wherein a chip groove is assigned to each major cutting edge and a pointing is performed in the region of the face end center.

8. The tool head as recited in claim 7, wherein the cone base adjoins the pointing in the direction of a rotational axis.

9. The tool head as recited in claim 7, wherein the pointing tapers into the cone base.

10. The tool head as recited in claim 1, wherein the cone has a cone angle within the range from 30° to 50°.

11. The tool head as recited in claim 1, wherein the cone has a cone angle of around 40°.

12. The tool head as recited in claim 1 wherein the major cutting edges form relative to each other a point angle within the range from 130° to 145°.

13. The tool head as recited in claim 1 wherein the major cutting edges form relative to each other a point angle of around 135°.

14. The tool head as recited in claim 1, wherein the cone has a front cone portion comprising the cone apex and a rear cone portion comprising the cone base, and the two cone portions have different cone angles.

15. The tool head as recited in claim 1, wherein the tool head is configured as a reversibly exchangeable drill head.
